(19) United States
(12) Patent Application Publication
(10) Pub. No.: US 2017/0116687 A1
(43) Pub. Date: Apr. 27, 2017

(54) METHODS SYSTEMS AND DEVICES FOR MATCHING DISTRIBUTED ENERGY CONSUMER PREFERENCES WITH DISTRIBUTED ENERGY INVESTOR PREFERENCES

(71) Applicants: Nalin Kulatilaka, Brookline, MA (US); David Arfin, Palo Alto, CA (US); Adam Cohen, Washington, DC (US)

(72) Inventors: Nalin Kulatilaka, Brookline, MA (US); David Arfin, Palo Alto, CA (US); Adam Cohen, Washington, DC (US)

(21) Appl. No.: 15/335,882

(22) Filed: Oct. 27, 2016

Related U.S. Application Data
(60) Provisional application No. 62/246,617, filed on Oct. 27, 2015.

(51) Int. Cl. G06Q 50/06; G06F 7/20; G06Q 40/06

(52) U.S. Cl. CPC G06Q 50/06; G06Q 40/06; G06F 7/20

(57) ABSTRACT

Devices, systems, and methods for matching distributed energy consumer preferences with distributed energy investor preferences are disclosed. In one aspect a computerized method comprises receiving preference-related data associated with a distributed energy consumer, determining a preference profile for the consumer, creating a personalized distributed energy asset for the consumer, and bundling the personalized distributed energy assets into a bundle of distributed energy assets. In another aspect the method comprises receiving preference-related data associated with a distributed energy investor, determining a preference profile for the investor, and matching the bundle of distributed energy assets with the investor.

### CROSS-REFERENCES TO RELATED APPLICATIONS

This application claims the benefit and priority of U.S. Provisional Application No. 62/246,617, entitled “METHODS SYSTEMS AND DEVICES FOR MATCHING DISTRIBUTED ENERGY CONSUMER PREFERENCES WITH DISTRIBUTED ENERGY INVESTOR PREFERENCES”, filed on Oct. 27, 2015, the full disclosure of the above referenced application is incorporated herein by reference.

### FIELD OF THE INVENTION

This invention relates generally to methods, systems, and devices for matching distributed energy consumer preferences with distributed energy investor preferences.

### DESCRIPTION OF THE RELATED ART

Energy generating or energy efficiency equipment can provide substantial utility savings as well as environmental benefits. Often though, purchasing this equipment may be prohibitively expensive and it might take a long time to recoup the initial investment through savings derived from the system. Assets such as equipment loans, equipment leases, power purchase agreements, shared savings agreements, and energy service agreements have been created in order to reduce or remove upfront cost allowing a much larger user base.

Decisions by consumers to adopt distributed energy assets rely on assumptions on future utility costs. As future utility costs may be highly uncertain, opting to adopt a distributed energy asset exposes consumers to risk of paying more for energy, rather than paying less. Consumers may have various preferences with regard to risk and reward. Likewise, investors may have varying preferences in risk tolerance and return requirements.

It would be desirable to provide alternative and improved methods, systems, and devices for matching distributed energy consumer preferences with distributed energy investor preferences. At least some of these objectives will be met by the invention described herein below.

### SUMMARY OF THE INVENTION

In one aspect, the present application discloses methods, systems, and devices for matching distributed energy consumer preferences with distributed energy investor preferences. In one embodiment a computerized method for matching distributed energy consumer preferences with distributed energy investor preferences comprises receiving by a processor, preference-related data associated with a distributed energy consumer, determining by the processor, a preference profile for the distributed energy consumer based on the received preference-related data, and creating by the processor, a personalized distributed energy asset for the consumer based on the determined consumer preference profile. The processor may then bundle multiple personalized distributed energy assets into a bundle of distributed energy assets. The method further comprises receiving by the processor, preference-related data associated with a distributed energy investor, determining by the processor, a preference profile for the distributed energy investor based on the received preference-related investor data, and matching by the processor, the bundle of distributed energy assets with the investor based on the investor preference profile.

In another embodiment a computerized method for matching distributed energy consumer preferences with distributed energy investor preferences comprises receiving by a processor, preference-related data associated with a distributed energy consumer, determining by the processor, a preference profile for the distributed energy consumer based on the received preference-related data, and creating by the processor, a personalized distributed energy asset for the consumer based on the determined consumer preference profile. The method further comprises receiving by the processor, preference-related data associated with a distributed energy investor, determining by the processor, a preference profile for the distributed energy investor based on the received preference-related investor data, and bundling by the processor, multiple personalized distributed energy assets into a personalized bundle of distributed energy assets matched to the investor based on the preference profile for the distributed energy investor.

In one aspect, preference-related data may comprise comprises empirical research data, behavioral data, demographic data, social network data, or location. In various embodiments, the bundle of distributed energy assets may comprise personalized distributed energy assets with different pricing, repayment, financing structures, time durations, or geographic locations.

In an embodiment, a personalized distributed energy asset with a floating energy rate indexed to utility price is created for a consumer with a preference profile indicating a preference for guaranteed monetary savings versus prevailing electric utility payments. In another embodiment, a personalized distributed energy asset with a fixed energy payment schedule is created for a consumer with a preference profile indicating a preference for stability in future utility payments. A personalized distributed energy asset with a floating energy rate capped at a given rate may be created for a consumer with a preference profile indicating a preference for a guaranteed maximum payment for energy. A personalized distributed energy asset with a collared energy asset with upper and lower bounds may also be created for a consumer with a preference profile indicating a preference for maximizing potential for future energy cost savings.

In another aspect, the processor may receive utility rate data and the personalized distributed energy assets may be based on the received utility rate data. The utility rate data may comprise present, historical, and projected utility rate data.

In various embodiments, the determined preference profile for the distributed energy investor may comprise a preference for a variable rate of return indexed to retail energy prices, a preference for a fixed rate of return independent of retail energy prices, or an interest in retail energy rates in a particular geographic region.

This, and further aspects of the present embodiments are set forth herein.

### BRIEF DESCRIPTION OF THE DRAWINGS

Present embodiments have other advantages and features which will be more readily apparent from the following detailed description and the appended claims, when taken in conjunction with the accompanying drawings, in which:

FIG. 1 shows an exemplary method for matching distributed energy consumer preferences with distributed energy investor preferences.

FIG. 2 shows a method for matching distributed energy consumer preferences with distributed energy investor preferences using a personalized pool of energy contracts.

FIGS. 3A-G show exemplary personalized energy contracts.

FIG. 4 shows an exemplary method of calculating estimated future retail utility rates.

FIG. 5 illustrates an exemplary system architecture according to one embodiment.

### DETAILED DESCRIPTION

While the invention has been disclosed with reference to certain embodiments, it will be understood by those skilled in the art that various changes may be made and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate like parts throughout the views. Additionally, a reference to the singular includes a reference to the plural unless otherwise stated or inconsistent with the disclosure herein.

The word “exemplary” is used herein to mean “serving as an example, instance, or illustration.” Any implementation described herein as “exemplary” is not necessarily to be construed as advantageous over other implementations.

The present disclosure describes methods, systems, and devices for matching distributed energy consumer preferences with distributed energy investor preferences. The term “energy” as referred to herein is defined to include electricity, natural gas, water, heating oil, and the like. The term “distributed energy resources” as referred to herein is defined to include energy or water related equipment such as energy generating systems (photovoltaic, solar hot water, solar thermal, wind energy, geothermal energy, hydroelectric, combined heat and power), distributed energy equipment, energy or water efficient equipment (appliances, lighting, HVAC, insulation, smart devices, sensors), heating/cooling systems (heating oil, gas, geothermal heat pumps), energy storage systems (battery storage, fuel cell systems, thermal storage, fly wheels, electric vehicles), systems for cleaning, processing, storing, or purifying water, energy efficient vehicles (electric, hybrid, fuel cell, etc.), and/or software that allocates/optimizes generation or usage of the above systems. In an embodiment, distributed energy resources may comprise demand-side management programs such as demand response and continuous commissioning.

Distributed energy resources may provide substantial energy or utility savings to residential, commercial, industrial, agricultural, governmental, educational, nonprofit, or any other user of energy or water. Often though, the initial investment to adopt such equipment can be quite large. Distributed energy assets such as equipment leases, equipment loans, power purchase agreements, shared savings agreements, energy service agreements, or the like, allow adoption of such equipment with reduced upfront cost to consumers of the distributed energy resources. Distributed energy assets may have cash flows of various durations that are borrowed against and/or sold into securitization markets. Distributed energy assets may comprise contracts to purchase all electricity produced from an energy-generating system over a given period. Alternatively, distributed energy assets may comprise contracts to purchase all consumed energy during a given period. Assets may be packaged or bundled with similar assets. They may, in turn, be repackaged, re-priced and resold.

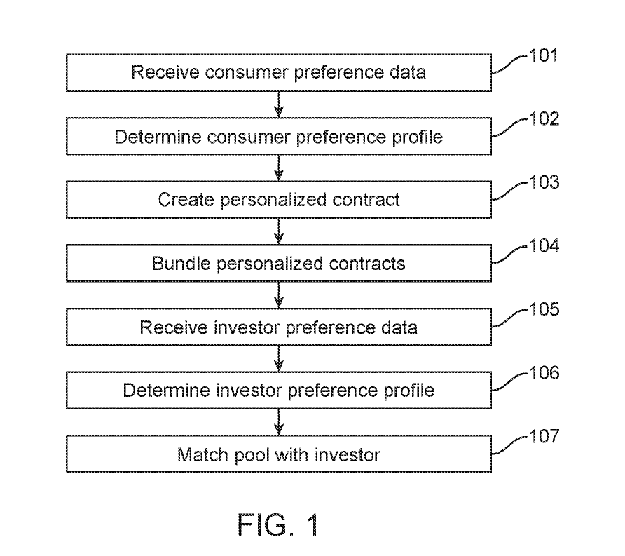

FIG. 1 shows an exemplary method for matching distributed energy consumer preferences with distributed energy investor preferences. At step 101, preference-related data associated with a distributed energy consumer is received. Received data may be any data relevant to the distributed energy consumer's preferences with regards to adopting a distributed energy asset such as empirical research data, behavioral data, demographics, social networks, location, utility data, government data, weather data, economic data, usage data, equipment performance data, event data, and/or technology data. Consumer preferences may be varied and depend on many financial and non-financial factors.

As energy is fungible, the economic value of distributed energy assets to consumers is their ability to reduce energy costs by replacing a certain quantity of the energy purchased from a utility. Further, in certain circumstances, for example in the presence of renewable energy certificates or carbon taxes, the economic value of energy may be related to its source, and hence a unit of green energy (e.g., solar-generated electricity) and a unit of brown energy (e.g., coal-generated electricity) may not be interchangeable from a financial perspective, although they are from a physical/engineering perspective. By considering distributed energy assets, consumers are essentially considering taking a financial swap between a status quo source of energy and a potentially lower cost option. Such consideration necessitates taking a financial position on the future of utility costs. Future changes in energy rates may be derived from tariff and pricing decisions of public utility commissions and utilities, technological developments, macroeconomic forces such as recession, events such as closing of power plants, developments of energy sources/distribution, or commodity prices. It is possible that actual future electricity rates/tariffs differ from the projections. While distributed energy assets may provide a financial benefit to consumers, since future utility costs may be highly uncertain, opting to adopt a distributed energy asset exposes consumers to risk of paying more for energy, rather than paying less.

Consumers may have differing preferences regarding risk, reward, timeframe, and certainty. Some consumers may be purely rational. Others may have varying degrees of loss aversion or a tendency to over weigh potential losses. Consumers may prefer avoiding losses to acquiring gains. In some instances the potential for loss may be twice as powerful as the opportunity for gain. Alternatively, some consumers may be more interested in maximizing potential gains and less interested in potential losses. Consumers may have varying degrees of risk aversion. Consumers may prefer lower, certain returns over higher but riskier returns. Other consumers may be risk neutral or risk seeking. Consumers may also have varying degrees of hyperbolic discounting or a tendency to under value future gains. Consumers may have differing opinions regarding short-term, mid-term, and long-term benefits or risks. Consumers may have differing opinions on the duration of agreements. For example, some consumers may be less willing to make long term agreements. Consumers may not want to wait a long time to accrue savings or prefer to get a smaller reward sooner rather than a larger reward later. Certainty in future costs may also be important to customers. Some consumers may have a status quo bias or a preference for the current state of affairs.

Additionally or alternatively, other non-financial factors such as interest in technology, environmental benefits, energy independence, social factors, or political factors may affect a consumer's decision on whether adopt a distributed energy asset or potential terms of the distributed energy asset.

At step 102, a preference profile for the distributed energy consumer is determined based on the received preference-related data associated with the distributed energy consumer. Exemplary preference profiles may comprise desires by consumers to minimize upfront costs, minimize risk, maximize reward, guarantee savings versus utility payments, provide stability in future payments for energy, guarantee a maximum payment for energy, maximize potential for future energy cost savings, high short-term benefit, high long-term benefit, etc.

At step 103, a personalized distributed energy asset is created based on the determined preference profile. The personalized distributed energy asset may also be based on estimated future utility rates for the consumers. Data from various sources such as data relating to regulations, taxes, government incentives, utility incentives, usage data, equipment performance data, utility pricing, macroeconomic data, weather, or technology data may be used to calculate estimated future utility rates.

In an embodiment, a single personalized distributed energy asset is created for the consumer. In another embodiment, multiple personalized distributed energy assets are created with different characteristics and the consumer is given the opportunity to select one of the provided options.

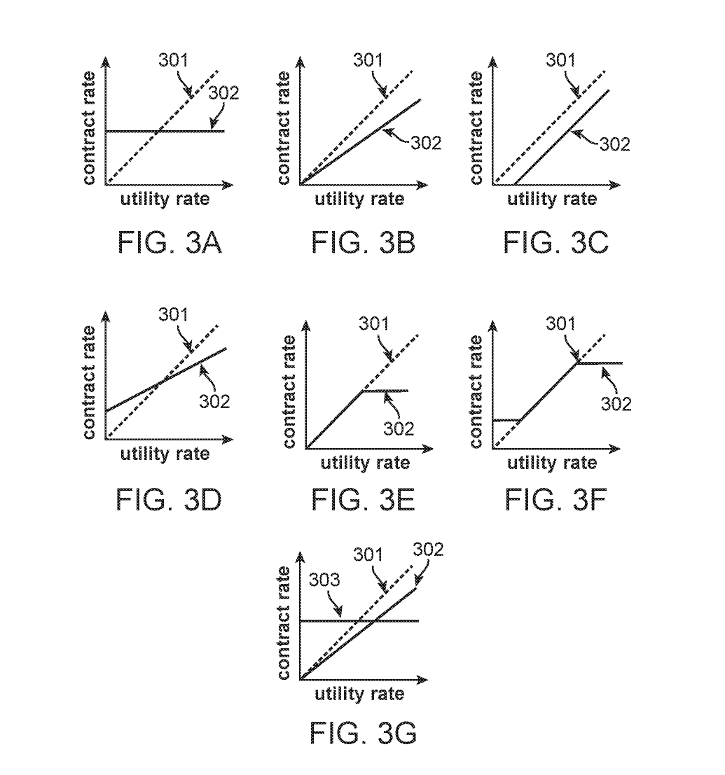

Personalized distributed energy assets may have various customized terms, durations, structures, etc. in order to meet the preferences of the consumer. Various exemplary distributed energy assets are shown in FIGS. 3A-G. Utility rate is indicated on the x-axis. The contract rate of various distributed energy assets may be set as mathematical functions of the utility rate. The functional form of the contract rate is indicated by lines 302. Dashed lines 301 indicate the rate a consumer would pay without agreeing to the distributed energy asset. If line 302 is below line 301 then the contract rate is less than the utility rate and the consumer is saving money by adopting the distributed energy asset. Likewise, if the line 302 is above line 301 then the contract rate is greater than the utility rate and the consumer is losing money by adopting the distributed energy asset. In an embodiment shown in FIG. 3A, distributed energy assets may comprise agreements by consumers to purchase energy at fixed rates 302 projected to be less than estimated future utility rates for the consumers. As an example, a distributed energy asset with a fixed rate 302 may be created for a consumer with a preference profile indicating a desire for stability in future payments for energy.

Distributed energy assets may also comprise agreements by consumers to purchase energy at variable rates as seen in FIGS. 3B-3G. In an embodiment, distributed energy assets may comprise a savings guarantee wherein consumers agree to purchase energy at variable rates which are tied to future utility rates or an index. As shown in FIG. 3B, a distributed energy asset with a variable rate 302 indexed to the utility price may be created for a consumer with a preference profile indicating a desire for a guaranteed savings versus utility payments. The variable rates of the distributed energy assets may be discounted by a percentage from the future utility rates for the consumers. For example, the consumer may agree to purchase energy at a five percent discount from future utility rates. Alternatively, variable rates of the distributed energy assets may discounted by a percentage from the total utility bill. Variable discounts from total bills may consider changes to net metering, energy demand or capacity charges, and/or surcharges/penalties/fees or discounts for customers who deploy distributed resources. Alternatively, as can be seen in FIG. 3C, the variable rates 302 of the distributed energy assets may discounted by a fixed value from the future utility rates for the consumers. For example, consumers may agree to purchase energy at a reduced rate. Assets may guarantee a fixed discount per month from the total consumer utility bill. Fixed discounts from total bills may consider changes to net metering, energy demand or capacity charges, or surcharges/penalties/fees or discounts for customers who deploy distributed resources. For example, the energy-related asset may guarantee a saving of $10 month. Additionally or alternatively, variable rates may be tied to average national utility rates, average regional utility rates, commodity prices, home prices, or inflation. While the term “discount” is used, it is also contemplated that the variable rates may be equal to or greater than future utility rates or indices.

Various other rate structures may be created based on the preferences of the consumer. In an embodiment shown in FIG. 3E a distributed energy asset with a floating energy rate 302 capped at a given rate may be created for a consumer with a preference profile indicating a desire for a guaranteed maximum payment for energy. FIG. 3F shows an exemplary distributed energy comprising a collared energy asset with an upper bound and a lower bound. Such an asset may be created for a consumer having a preference profile indicating a desire to maximize potential for future energy cost savings. FIG. 3G shows an exemplary distributed energy asset comprising a variable rate with an option 303 to fix the rate at a given value.

Returning to FIG. 1, at step 104, multiple personalized distributed energy assets are bundled into a bundle of distributed energy assets. The bundle of distributed energy assets may comprise multiple distributed energy assets with similar characteristics. The bundle of distributed energy assets may also comprise multiple distributed energy assets with differing characteristics. In an embodiment, the bundle of distributed energy assets comprises personalized distributed energy assets with different pricing, repayment, or financing structures. The bundle of distributed energy assets may also comprise personalized distributed energy assets for different utilities. In another embodiment, the bundle of distributed energy assets comprises personalized distributed energy assets with different time durations. The bundle of distributed energy assets may also comprise personalized distributed energy assets in different geographic regions. By varying the number of distributed energy assets in the bundle or the types of distributed energy assets in the bundle, many different bundles may be created with different characteristics.

At step 105, preference-related data associated with a distributed energy investor is received. Distributed energy investors may be any potential investor in the distributed energy asset. Received data may be any data relevant to the distributed energy investor's preferences with regards to investing in a distributed energy asset such as empirical research data, behavioral data, demographics, social networks, location, utility data, government data, weather data, economic data, usage data, equipment performance data, event data, and/or technology data. As with the distributed energy consumers, investors may have many different preferences regarding potential investments that may depend on many financial and non-financial factors.

At step 106, a preference profile for the distributed energy investor is determined based on the received preference-related data associated with a distributed energy investor. As an example, the system may create a preference profile for an investor indicating a desire for a variable rate of return indexed to retail energy prices. Alternatively, the system may create a preference profile for another investor indicating a desire for fixed rate of return independent of retail energy prices. In an embodiment, the system may create a preference profile for an investor indicating an interest in retail energy rates in particular region or territory. At step 107, the bundle of distributed energy assets is matched with the investor based on the preference profile for the distributed energy investor.

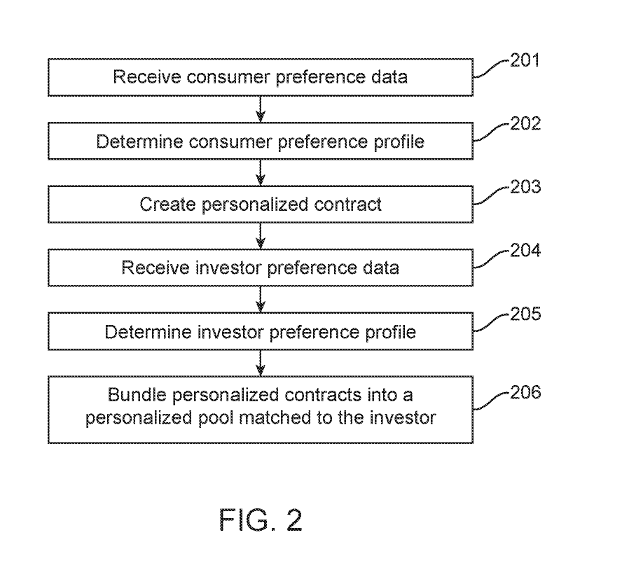

FIG. 2 shows an alternative method for matching distributed energy consumer preferences with distributed energy investor preferences using a personalized pool of energy contracts. At step 201, preference-related data associated with a distributed energy consumer is received. Received data may be any data relevant to the distributed energy consumer's preferences with regards to adopting a distributed energy asset such as empirical research data, behavioral data, demographics, social networks, location, utility data, government data, weather data, economic data, usage data, equipment performance data, event data, and/or technology data. Consumer preferences may be varied and depend on many financial and non-financial factors.

At step 202, a preference profile for the distributed energy consumer is determined based on the received preference-related data associated with the distributed energy consumer. Exemplary preference profiles may comprise desires by consumers to minimize upfront costs, minimize risk, maximize reward, guarantee savings versus utility payments, provide stability in future payments for energy, guarantee a maximum payment for energy, maximize potential for future energy cost savings, high short-term benefit, high long-term benefit, etc.

At step 203, a personalized distributed energy asset is created based on the determined preference profile. The personalized distributed energy asset may also be based on estimated future utility rates for the consumers. Data from various sources such as data relating to regulations, taxes, government incentives, utility incentives, usage data, equipment performance data, utility pricing, macroeconomic data, weather, or technology data may be used to calculate estimated future utility rates. In an embodiment, a single personalized distributed energy asset is created for the consumer. In another embodiment, multiple personalized distributed energy assets are created with different characteristics and the consumer is given the opportunity to select one of the provided options.

Personalized distributed energy assets may have various customized terms, durations, structures, etc. in order to meet the preferences of the consumer. In an embodiment, distributed energy assets may comprise agreements by consumers to purchase energy at fixed rates projected to be less than estimated future utility rates for the consumers. Distributed energy assets may also comprise agreements by consumers to purchase energy at variable rates. In an embodiment, distributed energy assets may comprise a savings guarantee wherein consumers agree to purchase energy at variable rates which are tied to future utility rates or an index. The variable rates of the distributed energy assets may be discounted by a percentage from the future utility rates for the consumers. Alternatively, variable rates of the distributed energy assets may discounted by a percentage from the total utility bill. Variable discounts from total bills may consider changes to net metering, energy demand or capacity charges, and/or surcharges/penalties/fees or discounts for customers who deploy distributed resources. Alternatively, the variable rates of the distributed energy assets may discounted by a fixed value from the future utility rates for the consumers. Assets may guarantee a fixed discount per month from the total consumer utility bill. Fixed discounts from total bills may consider changes to net metering, energy demand or capacity charges, or surcharges/penalties/fees or discounts for customers who deploy distributed resources. Additionally or alternatively, variable rates may be tied to average national utility rates, average regional utility rates, commodity prices, home prices, or inflation. While the term “discount” is used, it is also contemplated that the variable rates may be equal to or greater than future utility rates or indices.

At step 204, preference-related data associated with a distributed energy investor is received. Distributed energy investors may be any potential investor in the distributed energy asset. Received data may be any data relevant to the distributed energy investor's preferences with regards to investing in a distributed energy asset such as empirical research data, behavioral data, demographics, social networks, location, utility data, government data, weather data, economic data, usage data, equipment performance data, event data, and/or technology data. As with the distributed energy consumers, investors may have many different preferences regarding potential investments that may depend on many financial and non-financial factors.

At step 205, a preference profile for the distributed energy investor is determined based on the received preference-related data associated with a distributed energy investor. As an example, the system may create a preference profile for an investor indicating a desire for a variable rate of return indexed to retail energy prices. Alternatively, the system may create a preference profile for another investor indicating a desire for fixed rate of return independent of retail energy prices. In an embodiment, the system may create a preference profile for an investor indicating an interest in retail energy rates in particular region or territory.

At step 206, multiple personalized distributed energy assets are bundled into a personalized bundle of distributed energy assets based on the preference profile for the distributed energy investor. The number of distributed energy assets in the bundle or the types of distributed energy assets in the bundle may be varied in order to create a customized bundle with characteristics matched to the preferences of a specific investor. The bundle of distributed energy assets may comprise multiple distributed energy assets with similar characteristics. The bundle of distributed energy assets may also comprise multiple distributed energy assets with differing characteristics. In an embodiment, the bundle of distributed energy assets comprises personalized distributed energy assets with different pricing, repayment, or financing structures. In another embodiment, the bundle of distributed energy assets comprises personalized distributed energy assets with different time durations. The bundle of distributed energy assets may comprise personalized distributed energy assets in different geographic regions.

While the above methods describe matching bundles of personalized distributed energy assets with investors based on determined investor preference profiles, it is contemplated that pools of any distributed energy assets may be matched with an investor based on a determined investor profile. It is further contemplated that any distributed energy assets may be bundled into a customized bundle matched to an investor based on a determined preference profile of the investor. Alternatively a single distributed energy asset may be matched with a distributed energy investor.

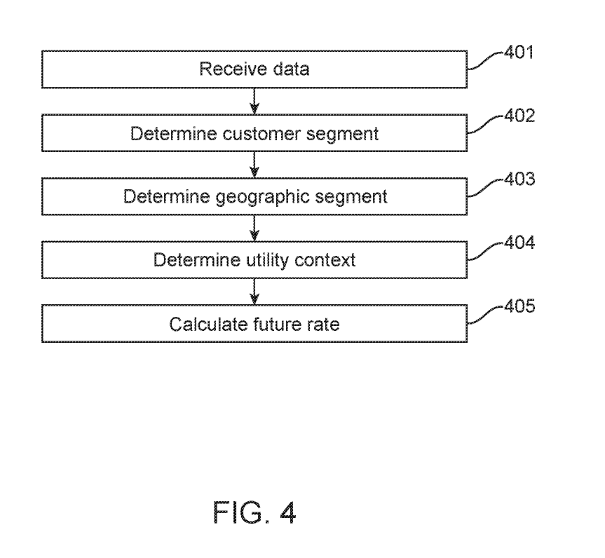

In any of the above systems or methods it may be desirable to calculate estimated future retail utility rates for a utility customer. FIG. 4 shows an exemplary method of calculating estimated future retail utility rates. At step 401, energy-related data comprising utility data, government data, weather data, economic data, usage data, event data, and/or technology data is received. At step 402, a relevant utility customer segment is determined for the utility customer. Utility customer segments may be based on utility customer sectors such as residential, commercial, industrial, agricultural, governmental, educational, or nonprofit. Utility customer segments may further be based on other factors such as income of the customer. At step 403, a geographic segment for the utility customer is determined. At step 404, the system then determines a utility effecting context to the utility data, government data, weather data, economic data, usage data, event data, and/or technology data. An estimated future retail utility rate is then calculated at step 405 based on the determined utility effecting context, utility customer segment, and geographic segment.

The system may repeat any of the above steps multiple times continuously or periodically in order to dynamically adjust the estimated future utility rate due to changes in relevant factors. In an embodiment, additional energy-related data representing additional factors not used in calculating the previously calculated estimated future utility rate or changes to factors used in calculating the previously calculated estimated future utility rate are received. The estimated future utility rate may then be recalculated based on the received additional energy-related data.

In one embodiment, calculating an estimated future retail utility rate comprises receiving energy-related data associated with a first geographic segment, and calculating an estimated future utility rate for a second geographic segment based on the received data associated with the first geographic region. In another embodiment, calculating an estimated future utility rate comprises predicting changes to taxes, statutes, or regulations.

In any of the above systems or methods it may be desirable to calculate risk, value, or price of a distributed energy asset. Risk, value, or price of the distributed energy asset may be calculated based on preference data, empirical research data, behavioral data, demographic data, social network data, location data, utility data, government data, weather data, economic data, usage data, equipment performance data, equipment servicing data, event data, technology data, financial data, credit data, promotional data, asset payments, estimated future utility pricing, the likelihood that the consumer will fulfill obligations on the distributed energy asset, and/or distributed energy asset terms, durations, or structures. In some aspects, updated data may be received continuously or periodically and the risk, value, or price of a distributed energy asset may be recalculated continuously or periodically in order to dynamically adjust the risk, value, or price over time due to changes in relevant factors.

Likewise, in any of the above systems or methods it may be desirable to calculate risk, value, or price of a bundle of distributed energy assets. Risk, value, or price of the bundle of distributed energy assets may be calculated based on preference data, empirical research data, behavioral data, demographic data, social network data, location data, utility data, government data, weather data, economic data, usage data, equipment performance data, equipment servicing data, event data, technology data, financial data, credit data, promotional data, asset payments, estimated future utility pricing, the likelihood that consumers will fulfill obligations on the distributed energy assets, and/or distributed energy asset terms, durations, or structures. In some aspects, updated data may be received continuously or periodically and the risk, value, or price of a bundle of distributed energy assets may be recalculated continuously or periodically in order to dynamically adjust the risk, value, or price over time due to changes in relevant factors

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in a computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

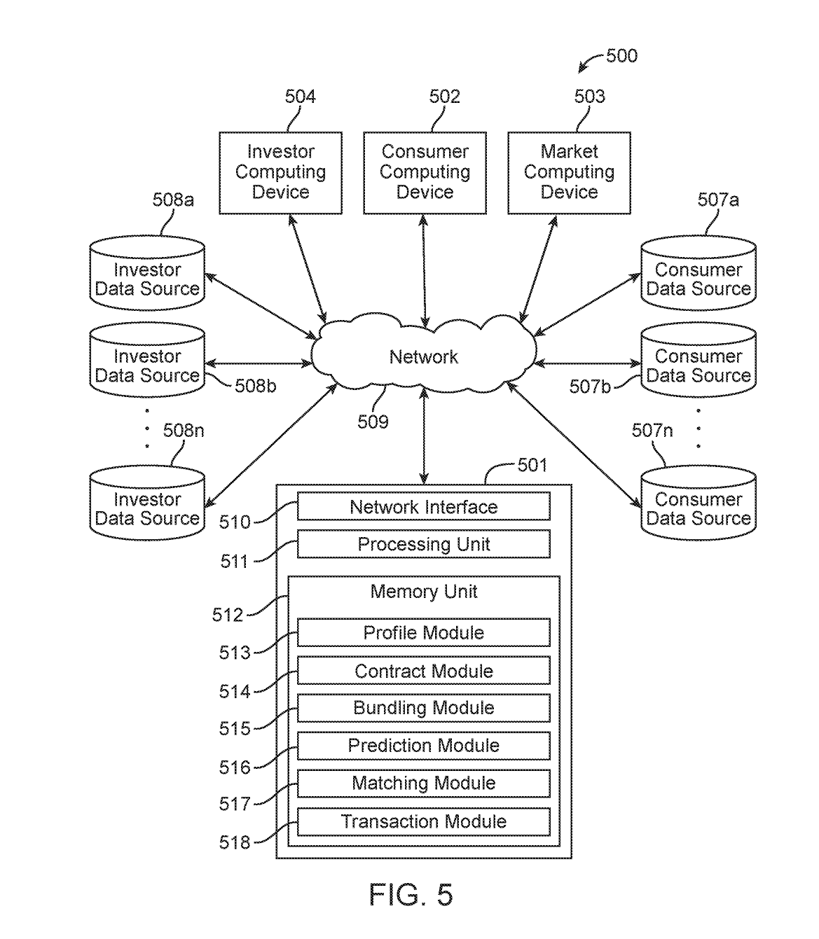

FIG. 5 illustrates an exemplary system architecture according to one embodiment. The system 500 may comprise one or more matching computing devices 501, one or more consumer computing devices 502, one or more investor computing devices 504 one or more market computing devices 503, one or more consumer data sources 507a-n, one or more investor data sources 508a-n, and one or more networks 509. The matching computing device 501 is configured to communicate with consumer computing device 502, market computing device 503, investor computing device 504, consumer data sources 507a-n, and/or investor data sources 508a-n over the network 509.

Computing devices 501, 502, 503, 504 and data sources 507a-n, 508a-n may comprise various components including but not limited to one or more processing units, memory units, video or display interfaces, network interfaces, input/output interfaces and buses that connect the various units and interfaces. The network interfaces enable the computing devices 501, 502, 503, 504 and data sources 507a-n, 508a-n to connect to the network 509. The memory units may comprise random access memory (RAM), read only memory (ROM), electronic erasable programmable read-only memory (EEPROM), and basic input/output system (BIOS). The memory unit may further comprise other storage units such as non-volatile storage including magnetic disk drives, optical drives, flash memory and the like.

In one embodiment the memory 512 may comprise a profile module 513, contract module 514, bundling module 515, prediction module 516, a matching module 517, and a transaction module 518. Profile module 513 may be configured to retrieve preference-related data associated with distributed energy consumers from consumer data sources 507a-n and create preference profiles for the distributed energy consumer based on the received preference related data. Profile module 513 may also be configured to retrieve preference-related data associated with distributed energy investors from investor data sources 508a-n and create preference profiles for the distributed energy investors based on the received preference related data.

Contract module 514 is configured to create personalized distributed energy assets for distributed energy consumers based on the preference profiles created by the profile module 513. Bundling module 515 may be configured to bundle distributed energy assets into bundles of distributed assets. In an embodiment, bundling module 515 bundles distributed energy assets into likely to be matched to different investor profiles. In another embodiment, bundling module 515 bundles distributed energy assets into personalized bundles of distributed energy assets designed to match preference profiles of specific investors.

Prediction module 516 may be configured to calculate estimated future utility rates for the consumers, energy usage associated with the consumers, energy production of equipment, and/or payments. Matching module 517 is configured to match assets or bundles of assets with investors. Transaction module 518 is configured to sell or buy assets or bundles of assets. Transaction module 518 may be configured to communicate or initiate various transactions directly with consumer computing device 502, and/or investor computing device 504. Transaction module 518 may also be configured to buy or sell assets or bundles of assets via transactions with a market computing device 503. The modules 513, 514, 515, 516, 517, 518 may be implemented as software code to be executed by the processing unit 511 using any suitable computer language. The software code may be stored as a series of instructions or commands in the memory unit 512.

While FIG. 5 depicts one matching computing device 501, one consumer computing device 502, one investor computing device 504, one market computing devices 503, and one network 509, this is meant as merely exemplary. Alternatively, any number of computing devices 501, 502, 503, 504, data sources 507a-n, 508a-n, or networks 509 may be present. Some or all of the components of the computing devices 501, 502, 503, 504 and/or the data sources 507a-n, 508a-n may be combined into a single component. Likewise, some or all of the components of the computing devices 501, 502, 503, 504 and/or the data sources 507a-n, 508a-n may be separated into distinct components.

Consumer data sources 507a-n provide data feeds that inform on events or factors related to the distributed energy consumer. This data may then be used to determine a preference profile for the distributed energy consumer or create a personalized distributed energy asset for the distributed energy consumer. Likewise, investor data sources 508a-n provide data feeds that inform on events or factors related to the investor. This data may then be used to determine a preference profile for the distributed energy investor, bundle distributed energy assets, or match a bundle of distributed energy assets with the investor. Data sources 507a-n, 508a-n may contain current data, historic data, and/or projected data. Data sources 507a-n, 508a-n may provide data specific to the individual consumers or investors. Data sources 507a-n, 508a-n may also provide data relating other similar consumers or investors or the population as a whole. Data sources 507a-n, 508a-n may comprise data from individuals or organizations with similar locations, groups, social networks, occupations, demographics, sectors, organizations, financial data, credit data, history, actions, behavior, habits, purchases, transactions, etc.

Data sources 507a-n, 508a-n may comprise any data relevant to preferences of the consumer or investor as well as any data relating to the cost of energy or relating to the distributed energy resources. Data sources 507a-n, 508a-n may comprise empirical research data such as data relating to behavioral economics data and motivations of consumers or investors. Data sources 507a-n, 508a-n may comprise behavioral data. Behavioral data may include data relating to the behavior of consumers or investors such as actions, habits, history, search history, browser history, purchases, transactions, previous contracts or investments, or the like.

Data sources 507a-n, 508a-n may comprise demographic data relating to any segment of the population at world, national, state, or local levels. Data sources 507a-n, 508a-n may also comprise social network data. Social networking data may provide information on the social interactions or social connections of the consumer or investor. Social network data may also provide data relating to individuals, groups, or organizations of the same or similar social networks. Location data may also be provided by data sources 507a-n, 508a-n. Data sources 507a-n, 508a-n may further provide financial or credit data relating to the consumers or investors. Preference related data may also be provided by consumers or investors. In an embodiment the system may ask consumers or investors one or more questions regarding their preferences relating to distributed energy resources, technology, the economy, energy prices, the environment, investments, risk, reward, return, wants, and/or needs.

Data sources 507a-n, 508a-n may comprise equipment performance data relating to the performance of the distributed energy equipment. Equipment performance may change over time due to many factors such as weather, quality, maintenance, or usage patterns. Adopted equipment may be monitored and performance can be rated based on actual performance. In one embodiment the equipment performance data source comprises sensors or other equipment adopted by the consumer.

Data sources 507a-n, 508a-n may comprise macroeconomic data at world, national, state, or local levels such as inflation/deflation data, CPI rates, employment data, commodity price data, home price data, recession/depression data, etc.

Data sources 507a-n, 508a-n may provide weather data relating to changes to average temperatures, precipitation, sunlight, wind, or other weather over time, hot or cold spikes in temperature, drought, flooding, earthquakes, natural disasters, or seasonal variation in weather.

Data sources 507a-n, 508a-n may comprise utility pricing data relating to the price of energy or water. Utility pricing data may provide data relating to tariff structures (net metering, tiering of rates, demand changes, time-of-use pricing, fixed rates, variable rates, etc.), energy or water rationing, regulation or deregulation, carbon taxes or credits, renewable energy certificates, changes in tax rates, changes to interpretation of tax or energy regulations, per unit rates, transmission fees, distribution policies, fuel mix, fuel prices, or events such as an oil embargo, refinery fires, closing or opening of utility plants.

Data sources 507a-n, 508a-n may comprise government related data at the federal, state, or local level relevant to the asset or off-taker. Data may include information relating to tax rates, forms of taxes, tax treatment, statutes or regulations, government incentives, policies, legal or administrative rulings, elections, or political forces.

Data sources 507a-n, 508a-n may provide usage data relating to the distributed energy assets or the consumer. In an embodiment, usage data may be provided by sensors, appliances, smart devices, meters, or other distributed energy resources associated with the consumer or off-taker. In another embodiment usage data is collected from a utility. Usage data may include data relating to past, current, or projected future usage. Usage data may also include energy consumption or production data, equipment use data, time of use data, duration of use data, or consumer behavioral data. Usage data may be based on various factors such as addition or subtraction of appliances or vehicles, addition or subtraction of energy generating equipment or distributed energy equipment, addition or subtraction of energy/water storage capabilities, changes to heating/cooling equipment, new or updated efficiency equipment or software, changes to equipment for cleaning, processing, storing, or purifying water, changes in time of use, changes in usage of the premises such as usage of the home as an office, etc., change in the number of occupants and intensity of usage, modifications to the property such as expansion or contraction, transfer of ownership, or change in occupants.

Energy-related technological data may also be provided by data sources 507a-n, 508a-n. Energy-related technological data may comprise data related to technological changes or predicted technological changes. For example, improved versions of consumer, off-taker, or utility equipment or new types of equipment that are more efficient or have additional features may emerge.

Data sources 507a-n, 508a-n may comprise promotional data from public or private sources such as manufacturers, utilities, installers, sellers, or government. For example, a new rebate, credit, and/or incentive may exist to replace existing equipment with new equipment. Existing incentives may also be removed over time. There may also be negative promotions such as assessments, penalties, use fees, connection charges, new taxes, etc.

The various components depicted in FIG. 5 may comprise computing devices or reside on computing devices such as servers, desktop computers, laptop computers, tablet computers, personal digital assistants (PDA), smartphones, mobile phones, smart devices, appliances, sensors, or the like. Computing devices may comprise processors, memories, network interfaces, peripheral interfaces, and the like. Some or all of the components may comprise or reside on separate computing devices. Some or all of the components depicted may comprise or reside on the same computing device.

The various components in FIG. 5 may be configured to communicate directly or indirectly with a wireless network such as through a base station, a router, switch, or other computing devices. In an embodiment, the components may be configured to utilize various communication protocols such as Global System for Mobile Communications (GSM), General Packet Radio Services (GPRS), Enhanced Data GSM Environment (EDGE), Code Division Multiple Access (CDMA), Wideband Code Division Multiple Access (WCDMA), Bluetooth, High Speed Packet Access (HSPA), Long Term Evolution (LTE), and Worldwide Interoperability for Microwave Access (WiMAX).

The components may be further configured to utilize user datagram protocol (UDP), transport control protocol (TCP), Wi-Fi, satellite links and various other communication protocols, technologies, or methods. Additionally, the components may be configured to connect to an electronic network without communicating through a wireless network. The components may be configured to utilize analog telephone lines (dial-up connection), digital lines (T1, T2, T3, T4, or the like), Digital Subscriber lines (DSL), Ethernet, or the like. It is further contemplated that the components may be connected directly to a computing device through a USB port, Bluetooth, infrared (IR), Firewire port, thunderbolt port, ad-hoc wireless connection, or the like. Components may be configured to send, receive, and/or manage messages such as email, short message service (SMS), instant message (IM), multimedia message services (MMS), or the like.

While the above is a complete description of the preferred embodiments of the invention, various alternatives, modifications, and equivalents may be used. Therefore, the above description should not be taken as limiting the scope of the invention which is defined by the appended claims.

What is claimed is:

1. A computerized method for matching distributed energy consumer preferences with distributed energy investor preferences comprising:
receiving by a processor, preference-related data associated with a distributed energy consumer;
determining by the processor, a preference profile for the distributed energy consumer based on the received preference-related data associated with the distributed energy consumer;
creating by the processor, a personalized distributed energy asset for the distributed energy consumer based on the determined preference profile for the distributed energy consumer;
bundling by the processor, multiple personalized distributed energy assets into a bundle of distributed energy assets;
receiving by the processor, preference-related data associated with a distributed energy investor;
determining by the processor, a preference profile for the distributed energy investor based on the received preference-related data associated with a distributed energy investor; and
matching by the processor, the bundle of distributed energy assets with the investor based on the preference profile for the distributed energy investor.

2. The method of claim 1, wherein the preference-related data associated with a distributed energy consumer comprises empirical research data.

3. The method of claim 1, wherein the preference-related data associated with a distributed energy consumer comprises behavioral data.

4. The method of claim 1, wherein the preference-related data associated with a distributed energy consumer comprises demographic data.

5. The method of claim 1, wherein the preference-related data associated with a distributed energy consumer comprises social network data.

6. The method of claim 1, wherein the preference-related data associated with a distributed energy consumer comprises location data.

7. The method of claim 1, wherein the bundle of distributed energy assets comprises personalized distributed energy assets with different pricing, repayment, or financing structures.

8. The method of claim 1, wherein the bundle of distributed energy assets comprises personalized distributed energy assets with different time durations.

9. The method of claim 1, wherein the bundle of distributed energy assets comprises personalized distributed energy assets in different geographic regions.

10. The method of claim 1, wherein the determined preference profile for the distributed energy consumer comprises a preference for guaranteed monetary savings versus prevailing electric utility payments, and the personalized distributed energy asset for the distributed energy consumer comprises a floating energy rate indexed to utility price.

11. The method of claim 1, wherein the determined preference profile for the distributed energy consumer comprises a preference for stability in future utility payments, and the personalized distributed energy asset for the distributed energy consumer comprises a fixed energy payment schedule.

12. The method of claim 1, wherein the determined preference profile for the distributed energy consumer comprises a preference for a guaranteed maximum payment for energy, and the personalized distributed energy asset for the distributed energy consumer comprises a floating energy rate capped at a given rate.

13. The method of claim 1, wherein the determined preference profile for the distributed energy consumer comprises a preference for maximizing potential for future energy cost savings, and the personalized distributed energy asset for the distributed energy consumer comprises a collared energy asset with an upper bound and a lower bound.

14. The method of claim 1, further comprising receiving by the processor utility rate data; and wherein the personalized distributed energy asset for the distributed energy consumer is further based on the received utility rate data.

15. The method of claim 14, wherein the utility rate data comprises present, historical, and projected utility rate data.

16. The method of claim 1, wherein the determined preference profile for the distributed energy investor comprises a preference for a variable rate of return indexed to retail energy prices.

17. The method of claim 1, wherein the determined preference profile for the distributed energy investor comprises a preference for a fixed rate of return independent of retail energy prices.

18. The method of claim 1, wherein the determined preference profile for the distributed energy investor comprises an interest in retail energy rates in a particular geographic region.

19. A computerized method for matching distributed energy consumer preferences with distributed energy investor preferences, comprising:
receiving by a processor, preference-related data associated with a distributed energy consumer;
determining by the processor, a preference profile for the distributed energy consumer based on the received preference-related data associated with the distributed energy consumer;
creating by the processor, a personalized distributed energy asset for the distributed energy consumer based on the determined preference profile for the distributed energy consumer;
receiving by the processor, preference-related data associated with a distributed energy investor;
determining by the processor, a preference profile for the distributed energy investor based on the received preference-related data associated with a distributed energy investor; and
bundling by the processor, multiple personalized distributed energy assets into a personalized bundle of distributed energy assets matched to the investor based on the preference profile for the distributed energy investor.

20. The method of claim 19, wherein the preference-related data associated with a distributed energy consumer comprises empirical research data.

21. The method of claim 19, wherein the preference-related data associated with a distributed energy consumer comprises behavioral data

22. The method of claim 19, wherein the preference-related data associated with a distributed energy consumer comprises demographic data.

23. The method of claim 19, wherein the preference-related data associated with a distributed energy consumer comprises social network data.

24. The method of claim 19, wherein the preference-related data associated with a distributed energy consumer comprises location data.

25. The method of claim 19, wherein the bundle of distributed energy assets comprises personalized distributed energy assets with different pricing, repayment, or financing structures.

26. The method of claim 19, wherein the bundle of distributed energy assets comprises personalized distributed energy assets with different time durations.

27. The method of claim 19, wherein the bundle of distributed energy assets comprises personalized distributed energy assets in different geographic regions.

28. The method of claim 19, wherein the determined preference profile for the distributed energy consumer comprises a preference for guaranteed monetary savings versus prevailing electric utility payments, and the personalized distributed energy asset for the distributed energy consumer comprises a floating energy rate indexed to utility price.

29. The method of claim 19, wherein the determined preference profile for the distributed energy consumer comprises a preference for stability in future utility payments, and the personalized distributed energy asset for the distributed energy consumer comprises a fixed energy payment schedule.

30. The method of claim 19, wherein the determined preference profile for the distributed energy consumer comprises a preference for a guaranteed maximum payment for energy, and the personalized distributed energy asset for the distributed energy consumer comprises a floating energy rate capped at a given rate.

31. The method of claim 18, wherein the determined preference profile for the distributed energy consumer comprises a preference for maximizing potential for future energy cost savings, and the personalized distributed energy asset for the distributed energy consumer comprises a collared energy asset with an upper bound and a lower bound.

32. The method of claim 18, further comprising receiving by the processor utility rate data; and wherein the personalized distributed energy asset for the distributed energy consumer is further based on the received utility rate data.

33. The method of claim 31, wherein the utility rate data comprises present, historical, and projected utility rate data.

34. The method of claim 18, wherein the determined preference profile for the distributed energy investor comprises a preference for a variable rate of return indexed to retail energy prices.

35. The method of claim 18, wherein the determined preference profile for the distributed energy investor comprises a preference for a fixed rate of return independent of retail energy prices.

36. The method of claim 18, wherein the determined preference profile for the distributed energy investor comprises an interest in retail energy rates in a particular geographic region.
